(19) United States
(12) Patent Application Publication
(10) Pub. No.: US 2004/0103016 A1
(43) Pub. Date: May 27, 2004

(54) Method and system for managing the supply of parts between a logistics provider and a manufacturer

(75) Inventors: Janice Sengmui Ho, Singapore (SG); Shajahan Mohamed, Singapore (SG)

Correspondence Address: MCDERMOTT, WILL & EMERY, 600 13th Street, N.W., Washington, DC, 20005-3096, US

(73) Assignee: SEAGATE TECHNOLOGY LLC

(21) Appl. No.: 10/716,669

(22) Filed: Nov. 20, 2003

Related U.S. Application Data
(60) Provisional application No. 60/429,297, filed on Nov. 25, 2002.

(51) Int. Cl. G06F 17/60

(52) U.S. Cl. 705/8

(57) ABSTRACT

A method and system for managing the supply of parts between a logistics provider and a manufacturer automatically detects usage of parts on a product line to automatically trigger a part pull request signal as a function of the detected usage. The detected usage signals are automatically translated to a shipping order that is forwarded over the public data network to a third party logistics provider at a separate geographic location. From the shipping order, a picking list is automatically generated by the third party logistics provider. Delivery information is then automatically generated based on the picking list and forwarded to the manufacturer.

### RELATED APPLICATIONS

This Application claims priority to provisional Application 60/429,297, filed on Nov. 25, 2002, the entire disclosure of which is hereby incorporated by reference.

### FIELD OF THE INVENTION

The present invention relates to a method and system for supplying parts between a logistics provider and a manufacturer.

### BACKGROUND

The term “Kanban” means “visible signal” in Japanese. Kanban signals are essentially demand signals from the customer, both external to and internal within the manufacturing or business process using them. Kanban demand signals authorize the beginning of work and, in effect, control the level of work in process and lead time for products. The use of these visible signals facilitates immediate feedback and abnormalities in the process to be addressed by immediate intervention activities or process improvement efforts. The application of Kanban to improve work flow in both manufacturing and office environments is a common practice. Kanban and just-in-time (JIT) manufacturing methods gained international awareness as Japanese manufacturers gained significant market shares for certain products. Various flow manufacturing and lean enterprise methods formalize improvement processes in manufacturing best practices. It has become more common in modern manufacturing to outsource warehouse and store operations to a third party logistics provider that supplies the parts needed to the manufacturer and their various manufacturing facilities or business units.

With the use of outsourcing of the warehouse and store operations, there arises a requirement to have an efficient means of communicating the parts or components' requirements to the third party logistics provider on a just-in-time basis. However, the sheer volume and complexity of modem manufacturing makes this a difficult process. For example, in an electronic assembly operation for disk drives, tens of millions of parts a day may be consumed, with several hundred different types of components a day being employed to produce hundreds of thousands of boards. Using conventional Kanban systems, there may be thousands of pull signals a day from a plurality of manufacturing sites at a plurality of different geographical locations. These geographically diverse and numerous pull signals converge onto a centralized logistics hub location.

In the past, Kanban systems, which employ “cards” for authorization of parts' release, have traditionally been highly manual and labor-intensive. However, in a high volume, diverse part manufacturing environment, as described above, a manual driven triggering system demand pull part request system is not suitable. Further, direct connectivity via a leased line between manufacturing units and the third party logistics provider has associated security issues and architectural issues that limit the usefulness of such a system.

### SUMMARY

There is a need for a method and system that improves upon a manual Kanban system and connectivity to a logistics provider at a different geographical location, to provide the functionality of replenishing manufacturing stocks at a manufacturing facility.

These and other needs are met by embodiments of the present invention which provide a computer-implemented method of managing supplying of parts between a logistics provider and a manufacturer. The method comprises the steps of automatically detecting usage of parts on a product line and automatically triggering a part pull request signal as a function of the detected usage. The part pull request signal is automatically translated to a shipping order. The shipping order is forwarded over a public data network from the manufacturer to a logistics provider at a different geographic location than the manufacturer. A picking list is automatically generated based on the part pull request signal and the shipping order. Delivery information is automatically generated to the manufacturer based on the picking list.

The automatic detection of usage of parts on a product line allows parts to be ordered only as and when they are consumed by production lines. The communication of the part requirements to the third party logistics provider is handled via machine to machine, even though the third party logistics provider is situated in a different geographic location. The automation provides shipping orders to support the pick process performed at the third party logistics provider. This methodology provides a closed loop integration of the systems on diverse platforms and in diverse geographical locations, at the same time supporting the large volume of parts and need for just in time manufacturing processes.

In other aspects of the invention, the earlier stated needs are also met by an integrated pull system network comprising at least one manufacturing facility for producing products and consuming parts. The network includes a parts consumption detector and a processor coupled to the parts consumption defector. The processor is configured to automatically trigger a part pull request signal in response to consumption of parts as detected by the parts consumption detector, and automatically translate the part pull request signal to a shipping order. A public data network interface is coupled to the processor and configured to forward the shipping order via the public data network to a logistics provider. The interface is also configured to receive delivery information from the logistics provider that is responsive to the shipping order.

The earlier stated needs are met by a still further aspect of the present invention, which provides a system for supplying parts to a manufacturing facility from a geographically distinct logistics provider. The system comprises a consumable parts usage detection system that automatically detects the usage of consumable parts and generates usage signals that indicate a quantity of consumable parts used at the manufacturing facility. Means are provided that are responsive to the usage signals for automatically interfacing the manufacturing facility with a logistics provider over a public data network to cause the logistics provider to replenish the consumable parts at the manufacturing facility and to provide delivery and shortage information to the manufacturing facility over the public data network.

The foregoing and other features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a system constructed in accordance with embodiments of the present invention.

FIG. 2 is a flow diagram of an exemplary process flow for creating shipping orders to be forwarded to the logistics hub for scheduling and delivering goods, in accordance with embodiments of the present invention.

FIG. 3 is a flow diagram of an exemplary flow for determining shortages, in accordance with embodiments of the present invention.

### DETAILED DESCRIPTION OF THE INVENTION

The present invention addresses and solves problems related to the replenishing of large volumes of different parts on a just-in-time basis, employing a third party logistics provider located in a different geographic location from the manufacturing facilities. These and other problems are solved, in part, by methods and systems according to the present invention that provide for the automatic detection of the usage of parts on product lines at the manufacturing sites. Based on the detected usage, part pull request signals are triggered automatically. From these part pull request signals, shipping orders are automatically generated and then forwarded over a public data network, such as the Internet, from the manufacturer to a logistics provider located at a different geographic location than the manufacturer. From the shipping order, which has been automatically generated, a picking list is automatically generated at the logistics provider and delivery of the requested parts may be provided. A closed loop feedback is also provided by automatically generating delivery information at the logistics provider, this delivery information then being provided to the manufacturer. Other information, such as shortage information, may be determined on a periodic basis based on the delivery information. The system is an open interface system that allows third parties, such as subcontractors, to also provide shipping orders over the public data network to the logistics provider. Additionally, certain requests may also be made manually and input into the system at the manufacturer so that detected usage of parts may be supplemented by conventional manual requests for parts.

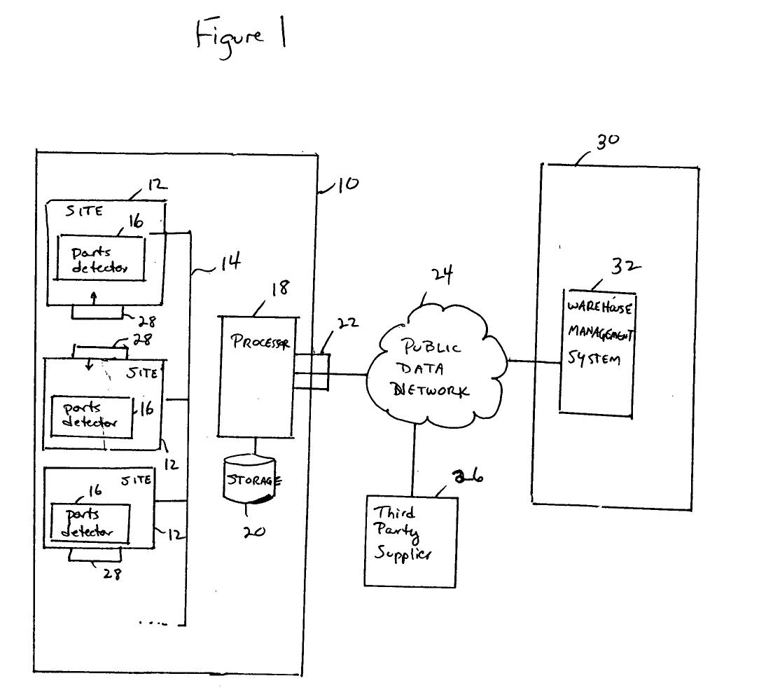

FIG. 1 depicts a block diagram of an exemplary system constructed in accordance with embodiments of the present invention and implementing the methods of the present invention. The system may be employed in a manufacturing enterprise 10 comprising a plurality of manufacturing sites 12. In certain embodiments of the invention, the individual manufacturing sites 12 are located in different geographic locations. An intranet 14, or other networking system, interconnects the manufacturing sites 12.

In the illustrated embodiment, each of the manufacturing sites 12 has electronic assembly operations (EAO) for assembling products, such as boards for disk drives. The particular manufacturing devices are not illustrated so as not to obscure the present invention. Indicated at each site, however, are parts consumption detectors 16 that keep track of the quantity of each part that is being currently used (or consumed) during the manufacturing of the products. Hence, as a particular component is being consumed by assembly into a product, the parts consumption detector 16 acts to identify and detect the consumption of this part. Further, the parts consumption detector 16 provides a signal indicating the detected usage of the part. Each manufacturing site 12 has a plurality of parts consumption detectors 16 keeping track of the hundreds of different types of parts employed in the production of the finished products. A parts consumption detector that indicates the usage or consumption of a part into a product or assembly is well known.

Rather than manual triggering of shipping orders and deliveries via a direct leased line to a third party logistics provider, the invention provides for automatic triggering based on the automatic detected usage of the parts by the parts consumption detector 16. The usage detection signals are sent by the parts consumption detector 16 from the manufacturing sites 12 over the internet 14 to a centralized processor 18. This configuration is exemplary only as each manufacturing site 12 may have its own processor or processors to perform the interfacing with the logistics provider. However, in the exemplary embodiment, the single processor 18 receives the detected usage signals from the various manufacturing sites 12 and processes the signals in accordance with programs stored within a conventional computer storage medium 20.

The processor 18, while operating in accordance with the programs stored in computer storage 20, receives the detected usage signal that automatically triggers the processor 18 to generate a part pull request signal based on the detected usage. From the part pull request signal, the processor 18 formulates a shipping order that will be sent to the third party logistics provider. The shipping order may be formulated in any suitable language, such as extended markup language (XML) suitable for transmission on the public data network 24. In certain embodiments of the invention, the public data network 24 is the Internet, for example. The public data network interface 22 may be any conventional form of suitable interface, such as a modem, for example.

In addition to the manufacturing sites 12, a third party supplier 26, such as a subcontractor, may also provide shipping orders to the logistics provider via the public data network 24. Also, in addition to the automatic detection of the usage of parts by the parts consumption detectors 16, manually created demands may be entered via a manual interface 28 provided at the manufacturing sites 12 or other locations. This allows for manual input of supply demands in addition to those demands created by the usage of parts, permitting special orders to be accepted..

The logistics provider 30 is also coupled to the public data network 24 and receives the shipping orders from this network 24. In the following description, the logistics provider 30 may be considered to be a “third party” logistics provider 30, or may also be any other type of supplier of parts, including a “carton box” supplier, for example. Furthermore, the logistics hub or logistics center does not have to be a third party provider 30, but can also be owned by the manufacturer 10. The terms “third party logistics provider 30” or “logistics provider 30” will therefore be used in this description of the invention to mean a supplier of parts. The logistics provider 30 has a logistics hub or logistics center with a warehouse management system 32

The warehouse management system 32 receives the shipping orders generated by the processor 18 and communicated to the third party logistics provider 30 over the public data network 24. From the shipping orders, the warehouse management system 32 automatically generates a picking list. From the picking list, deliveries of the consumable parts are scheduled and made to the manufacturing sites 12. The warehouse management system 32, based on the picking list, automatically generates delivery information that is sent back to the processor 18 via the public data network 24. The delivery information informs the manufacturing sites 12 of the necessary delivery information. Based on the delivery information, the processor 18 at the manufacturer 10 generates shortage information. The shortage information is used by managers at the manufacturing sites 12 as necessary. The shortage information may be updated periodically, such as by auto refreshing the status every 10 seconds.

Due to the closed loop system provided by the present invention, the automatic passing back and forth of information between the manufacturer 10 and the third party logistics provider 30, planners at the manufacturing sites 12 need only monitor shortages of parts as the process is seamlessly integrated.

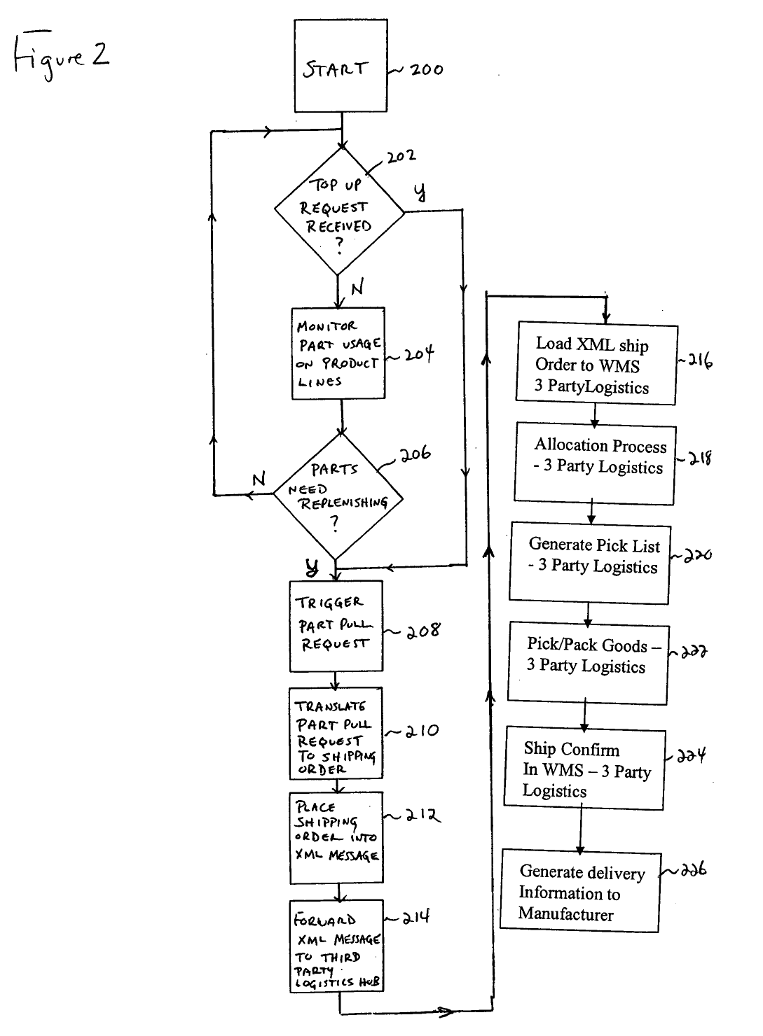

FIG. 2 is a simplified exemplary flow diagram of the process to create shipping orders at the manufacturer 10 or the third party supplier 26. From a start 200 it is determined whether a top up request (a manual created demand) has been performed. If such a manual top up request has been ordered, the process skips ahead to step 208. However, assuming a manual top up request has not been input at a manufacturing site through the interface 28, the process proceeds to step 204 in which the part usage is monitored on the product lines by the parts consumption detectors 16. The usage may be detected, for example, when parts are issued through the assembly lines. It is next determined in step 206 whether any part needs replenishing based upon the usage signals provided by the parts consumption detectors 16. If parts do not need replenishing, as determined in step 206, the process returns to step 202 (or in other embodiments, step 204).

Assuming that one or more different types of parts need replenishing, the process continues to step 208 in which a part pull request signal is automatically triggered as a function of the detected usage. In the above described embodiment, the part pull request signal is generated by the processor 18. However, in other embodiments, the part pull request signal is triggered at the different manufacturing sites 12 and it is this signal that is then provided to the processor 18 over the intranet 14.

In any event, the processor 18 forms an automatic translation of the part pull request signal into a shipping order, as provided for in step 210. The shipping order is formed into an XML message in step 212 for transmission over the public data network 24, through the public data network interface 22, to the third party logistics provider 30, as provided for in step 214. The XML ship order is loaded to the warehouse management system 32 of the third party logistics provider 30, in step 216.

An allocation process is performed at the third party logistics provider 30, in step 218, to allocate goods among requesters. After the allocation process, the third party logics provider 30 generates a pick list, in step 220, employing the warehouse management system 32. The goods are picked and packed by the third party logistics provider 30, in step 222. The warehouse management system 32 confirms the shipment, in step 224. Delivery information is automatically generated to the manufacturer, in step 226.

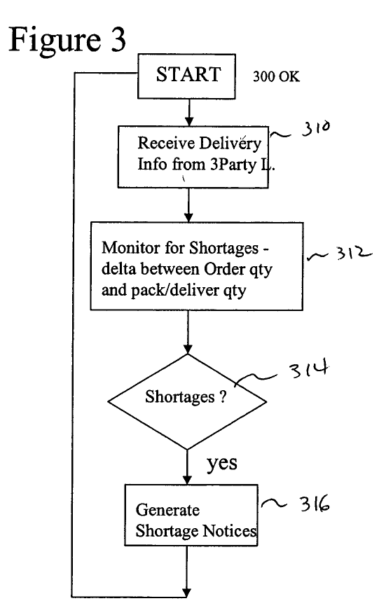

FIG. 3 depicts a simplified flow chart of a method followed by the processor 18 to monitor shortages in accordance with the present invention. From start state 300, the processor 18 receive delivery information from the third party logistics provider 30, as provided for in step 226 of FIG. 2. The processor 18 monitors for shortages in step 312. This is done by monitoring the difference (delta) between the order quantity and the pack/deliver quantity. If there are shortages, as determined in decision step 314, shortage notices are sent to the planners at the manufacturer 10, in step 316. Planners at the manufacturer 10 receive these shortage notices and can take appropriate action accordingly. The shortage information may be refreshed periodically, such as every 10 seconds, for example. If no shortages are detected, then the process returns to the start state 300.

In the present invention, the means responsive to the usage signals for automatically interfacing the manufacturing with logistics provider over a public data network to cause a logistics provider to replenish the consumable parts at the manufacturing facility and to provide delivery and shortage information to the manufacturing facility over the public data network may be considered to include the processor 18 and program stored in the conventional computer storage 20, as well as the warehouse management system 32 and operating software for that system, in certain embodiments of the invention. In other embodiments, the means includes only the operating software.

Although the present invention has been described and illustrated in detail, it is to be clearly understood that the same is by way of illustration and example only and is not to be taken by way of limitation, the scope of the present invention being limited only by the terms of the appended claims.

What is claimed is:

1. A computer-implemented method of managing supplying of parts between a logistics provider and a manufacturer, comprising the steps:
automatically detecting usage of parts on a product line;
automatically triggering a part pull request signal as a function of the detected usage;
automatically translating the part pull request signal to a shipping order;
forwarding the shipping order over a public data network from the manufacturer to the logistics provider at a different geographic location than the manufacturer;
automatically generating a picking list based on the part pull request signal and the shipping order; and
automatically generating delivery information to the manufacturer based on the picking list.

2. The method of claim 1, wherein the public data network is the Internet.

3. The method of claim 2, wherein the shipping order and the delivery information are transmitted using extended markup language (XML).

4. The method of claim 3, wherein the forwarding of the shipping order from the manufacturer to the logistics provider is a peer-to-peer transmission.

5. The method of claim 1, wherein the manufacturer comprises multiple manufacturing sites, with at least two of the sites forwarding shipping orders and receiving delivery information.

6. The method of claim 1, further comprising inputting manually created demand data and automatically triggering a part pull request signal based on the manually created demand data.

7. The method of claim 1, further comprising automatically generating shortage information based on delivery information generated by the logistics provider and forwarded to the manufacturer.

8. The method of claim 7, further comprising automatically refreshing the shortage information on a periodic basis.

9. The method of claim 1, further comprising a third party interface configured to enable a third party distinct from the manufacturer to forward shipping orders to the logistics provider and receive delivery information.

10. The method of claim 5, further comprising setting inventory checks by at least one of manufacturing site and commodity code.

11. An integrated demand pull system network, comprising:
at least one manufacturing facility for producing products and consuming parts;
a parts consumption detector;
a processor coupled to the parts consumption detector, the processor configured to: automatically trigger a part pull request signal in response to consumption of parts as detected by the parts consumption detector; and automatically translate the part pull request signal to a shipping order; and
a public data network interface coupled to the processor and configured to forward the shipping order via the public data network to a logistics provider, and to receive delivery information from the logistics provider that is responsive to the shipping order.

12. The network of claim 11, wherein the processor is coupled to computer program media, the processor being configured by a computer program stored in the computer program media.

13. The network of claim 12, wherein the public data network is the Internet.

14. The network of claim 13, wherein a plurality of manufacturing facilities are coupled together by an intranet, with at least two of the manufacturing facilities each having at least one parts consumption detector coupled to the processor through the intranet.

15. The network of claim 14, further comprising a manual entry interface coupled to the processor and configured to accept manually created demand data, the processor being further configured to automatically trigger a pull part request signal as a function of the manually created demand data.

16. The network of claim 15, further comprising a third party interface coupled to the public data network and configured to forward shipping orders via the Internet to the logistics provider.

17. The network of claim 11, further comprising the logistics provider coupled to the public data network and having a warehouse management system configured to receive the shipping order and automatically generate a picking list based on the shipping order.

18. The network of claim 17, wherein the warehouse management system is further configured to generate the delivery information based on the generated picking list.

19. The network of claim 18, wherein the warehouse management system is further configured to generate shortage information and provide the shortage information to the processor via the public data network on a periodic basis.

20. A system for supplying parts to a manufacturing facility from a geographically distinct logistics provider, comprising:
a consumable parts usage detection system that automatically detects the usage of consumable parts and generates usage signals that indicate a quantity of consumable parts used at the manufacturing facility; and
means responsive to the usage signals for automatically interfacing the manufacturing facility with the logistics provider over a public data network to cause the logistics provider to replenish the consumable parts at the manufacturing facility and to provide delivery and shortage information to the manufacturing facility over the public data network.
